(19) United States
(12) Patent Application Publication
(10) Pub. No.: US 2026/0269446 A1
(43) Pub. Date: Sep. 10, 2026

(54) WAVEGUIDE ELEMENT AND METHOD FOR PRODUCING A WAVEGUIDE ELEMENT, AND ALSO RADIOFREQUENCY ARRANGEMENT AND RADAR SYSTEM

(71) Applicant: Robert Bosch GmbH, Stuttgart (DE)

(72) Inventors: Ralph Schertlen, Stuttgart (DE); Marcel Mueller, Reutlingen (DE)

(21) Appl. No.: 19/165,352

(22) PCT Filed: May 15, 2024
(86) PCT No.: PCT/EP2024/063391

§ 371 Date: Sep. 15, 2025

(30) Foreign Application Priority Data
Jul. 3, 2023 (DE) 10 2023 206 267.4

(51) Int. Cl. H01P 3/127; G01S 7/03; H01P 3/123

(52) U.S. Cl. CPC H01P 3/127; G01S 7/03; H01P 3/123

(57) ABSTRACT

A waveguide element, in particular a hollow waveguide for transmission of electromagnetic waves. The waveguide element has a cavity surrounded by an electrically conductive material. The cavity is designed so as to afford for electromagnetic waves an effective width which is larger than the actual dimension of the cavity.

### FIELD

The present invention relates to a waveguide element and to a method for producing a waveguide element. The present invention further relates to a radiofrequency arrangement and radar system having such a wave element.

### BACKGROUND INFORMATION

Waveguide elements such as hollow waveguides may be used for transmitting radiofrequency signals. Such hollow waveguides can have different geometries, for example rectangular, round or elliptical cross-sections. The minimum width of the hollow waveguide should generally be slightly larger than half the wavelength of the electrical wave that can propagate in the hollow waveguide. The geometry of the hollow waveguide results in a lower limit frequency which is referred to as the cut-off frequency.

For example, Europe Patent Application No. EP 3903376 A1 describes a hollow waveguide arrangement for guiding electromagnetic waves.

### SUMMARY

The present invention provides a waveguide element, a method for producing a waveguide element, and a radiofrequency arrangement and radar system. Advantageous example embodiments of the present invention are disclosed herein.

Accordingly, the following is provided according to an example embodiment of the present invention:

A waveguide element for guiding an electromagnetic wave. The waveguide element is formed from an electrically conductive material that surrounds a cavity. This cavity is designed to guide the electromagnetic wave. The cavity has a cross-section that is generally perpendicular to a propagation direction of the electromagnetic wave. However, the cavity can in principle also have a wave-compatible curvature. Said cavity has an alternating regular structure in the direction of the cross-section along a virtual line.

Furthermore, according to an example embodiment of the present invention, the following is provided:

A radiofrequency arrangement having a waveguide element according to the present invention and a radiofrequency circuit. The radiofrequency circuit is coupled to the waveguide element.

Furthermore, according to an example embodiment of the present invention, the following is provided:

A radar system having a transmitting and/or receiving unit and a waveguide element according to the present invention which is coupled to the transmitting and/or receiving unit.

Additionally, according to an example embodiment of the present invention, the following is provided:

A method for producing a waveguide element. The method comprises a step of providing a body and a step of introducing a continuous cavity into the body. The cavity can be introduced by drilling, milling or another mechanical machining method. The body may preferably be a metallic, i.e. electrically conductive, body. Alternatively, a non-electrically conductive body can also be used, which is provided with an electrically conductive coating in the edge region after the cavity has been introduced. The cavity has a cross-section perpendicular to a propagation direction of the electromagnetic wave. Said cross-section has an alternating regular structure along a virtual line in the direction of the cross-section.

When designed conventionally, waveguide elements such as hollow waveguides provided for transmitting radiofrequency signals generally require a minimum width that is slightly larger than half the wavelength of the electromagnetic wave that is to propagate in the waveguide element. The dimensions, in particular the width of such a waveguide element, thus results in a lower cut-off frequency. Conversely, the minimum dimensions of the relative waveguide element result from the minimum frequency that is to be transmitted by the waveguide element.

Based on this finding, one example feature of the present invention is to provide a waveguide element in the form of a hollow waveguide or a dielectrically filled and metallically edged waveguide, which has improved properties as regards the relationships between dimensions and lower cut-off frequency.

This requirement can be achieved according to the present invention by providing a special design for the interior of such a waveguide element. In particular, the cavity of such a waveguide element can be formed in the form of a geometric structure resulting from an alternating regular structure along a virtual line in a cross-section of the waveguide element. As will be explained in more detail below, said regular structure can be formed in a variety of ways.

In particular, geometric structures can be formed for the interior of the waveguide element, which structures can also be realized particularly easily by means of mechanical processes such as drilling or milling. Thus, the waveguide element according to the present invention can also be produced particularly easily.

The edge of the cavity has an electrically conductive structure. For example, the waveguide element can be formed from an electrically conductive material into which the cavity is introduced. Alternatively, it is also possible to provide only the edge region between the body and the cavity with an electrically conductive material. The edge region can be made entirely of an electrically conductive material. For example, the edge region can be coated with an electrically conductive material. Alternatively, other electrically conductive structures, not necessarily covering the entire surface, such as grid-like structures, can also be used for the edge region. The electrically conductive edge region should have a thickness that is sufficient to reflect the electromagnetic waves.

As will be explained in more detail below, the cavity can be filled with air, a gas or another suitable, preferably solid dielectric.

According to one example embodiment of the present invention, the cross-section of the cavity has a periodic regular structure. Periodic structures are understood to mean any suitable structures that are repeated numerous times along the virtual line in the cross-section of the waveguide element.

According to one example embodiment of the present invention, the cross-section comprises a plurality of overlapping circles or polygons. Circles, for example, can be realized with a corresponding diameter particularly easily by drilling or milling. Polygons can be, for example, quadrilaterals, especially rectangles or squares. In principle, however, polygons, in particular regular polygons having more than four corners, are also possible. Since the individual geometric elements overlap, this results in a coherent cavity.

According to one example embodiment of the present invention, the overlapping circles or polygons are the same size. As a result, the structure according to the present invention for the waveguide element can be produced particularly easily and without changing tools. Alternatively, structures with circles or polygons of different sizes are also possible.

According to one example embodiment of the present invention, the cross-section of the cavity has a structure consisting of a plurality of overlapping alternating structures. For example, the geometry of the cross-section can also be formed from two structures that are axially symmetric with respect to the virtual line.

According to one example embodiment of the present invention, the cavity is filled with a gaseous or solid dielectric. Air, for example, can also be used as a gaseous dielectric. In addition, depending on the application, a dielectric with a higher dielectric constant can also be provided.

According to one example embodiment of the present invention, the waveguide element comprises a metallic body. The cavity can be introduced into said metallic body by drilling, milling or another mechanical machining method. In this way, the waveguide structure according to the present invention can be realized Substitute Specification particularly easily by means of mechanical manufacturing processes.

Alternatively, the waveguide can basically also be formed from a body that is not entirely made of a metallic or electrically conductive material. The desired structure for the cavity can also be introduced by drilling, milling or another mechanical machining method. The edge of the cavity can then be coated with an electrically conductive material. Any suitable method for coating the edge region in the cavity is possible.

In an alternative example embodiment of the present invention, the waveguide element can be realized by means of an extrusion process or the like.

The above example embodiments and developments can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the respective basic forms of the present invention.

### BRIEF DESCRIPTION OF THE DRAWINGS

Further features and advantages of the present invention will be explained in the following with reference to the figures.

FIG. 1 shows a schematic representation of a cross-section through a waveguide element according to one example embodiment of the present invention.

FIG. 2 shows a schematic representation of a cross-section through a waveguide element according to another example embodiment of the present invention.

FIG. 3 shows a schematic representation of a cross-section through a waveguide element according to another example embodiment of the present invention.

FIG. 4 shows a schematic representation of a cross-section through a waveguide element according to yet another example embodiment of the present invention.

FIG. 5 shows a schematic representation of a cross-section through a waveguide element according to another example embodiment of the present invention.

FIG. 6 shows a schematic representation of a cross-section through a waveguide element according to another example embodiment of the present invention.

FIG. 7 shows a schematic representation of a cross-section through a waveguide element according to yet another example embodiment of the present invention.

FIG. 8 shows a flowchart of a method for producing a waveguide element according to one example embodiment of the present invention.

### DETAILED DESCRIPTION OF EXAMPLE EMBODIMENTS

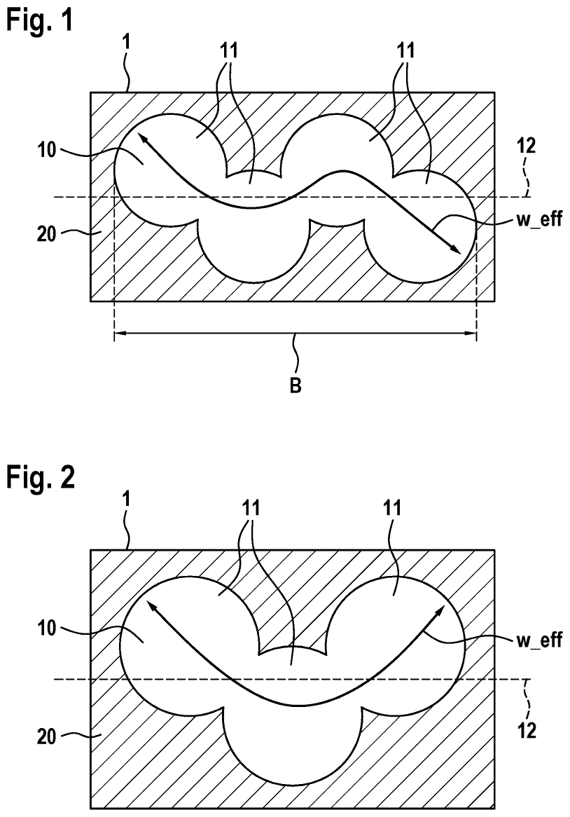

FIG. 1 shows a schematic representation of a cross-section through a waveguide element 1 according to one embodiment. The waveguide element 1 is formed by a cavity 10 which is enclosed by an electrically conductive material 20, for example a metal. The cavity 10 can, for example, be filled with a solid or gaseous dielectric. In particular, such a dielectric can also be air. The waveguide element 1 extends in a direction perpendicular to the plane of the drawing with an at least approximately constant cross-section. Thus, an electromagnetic wave can propagate in the cavity 10 of the waveguide element 1.

Such a waveguide element 1 can be used, for example, for any radiofrequency technology products, in particular in applications in which a hollow waveguide is to be used for transmission of electromagnetic waves. For example, such a waveguide element can be used for a radar system such as a motor vehicle radar. Here, the waveguide element 1 can be used in particular for signal decoupling and coupling from a radar circuit, for example an ASIC or the like, in or through a printed circuit board.

As can be seen in FIG. 1, the cross-section of the waveguide element 1 for the cavity 10 has a structure which has an alternating regular structure along a virtual line 12. In FIG. 1, said regular structure is formed, for example, by a plurality of circular elements 11, the centers of which are alternately located below or above the virtual line 12.

Such a structure of the cavity 10 makes it possible to obtain an effective width w_eff for an electromagnetic wave in said waveguide element 1 which is significantly larger than a width B of the cavity 10 along the virtual line 12. Accordingly, such an increased effective width w_eff can also increase the lower cut-off frequency of the waveguide element 1. In particular, such a configuration of the waveguide element 1 results in a lower cut-off frequency that is significantly higher than a hollow waveguide element having a rectangular cross-section of width B.

In the exemplary embodiment shown in FIG. 1, the cavity 10 is formed, for example, from four circular elements 11, which all have the same diameter. However, as will be explained in more detail below, the present invention is not limited to embodiments with four circles or other geometric elements. Rather, the cavity 10 can also be realized by other suitable structures which with respect to the width B allow for an increased effective width w_eff.

For a cavity 10 having a cross-section consisting of a plurality of overlapping circular elements, the cavity 10 can be formed, for example, by drilling into a (solid) metal body. However, other mechanical machining methods such as milling or the like are also possible.

In principle, it is also possible to realize the waveguide element 1 for example by another manufacturing process, such as extrusion or the like.

FIG. 2 shows a schematic representation of a cross-section through a waveguide element 1 according to another embodiment. The waveguide element 1 according to FIG. 2 differs from the above-described embodiment in particular in that the cavity 10 is formed here by only three geometric elements, in particular circles. In addition, all explanations given above in FIG. 1 apply to this embodiment.

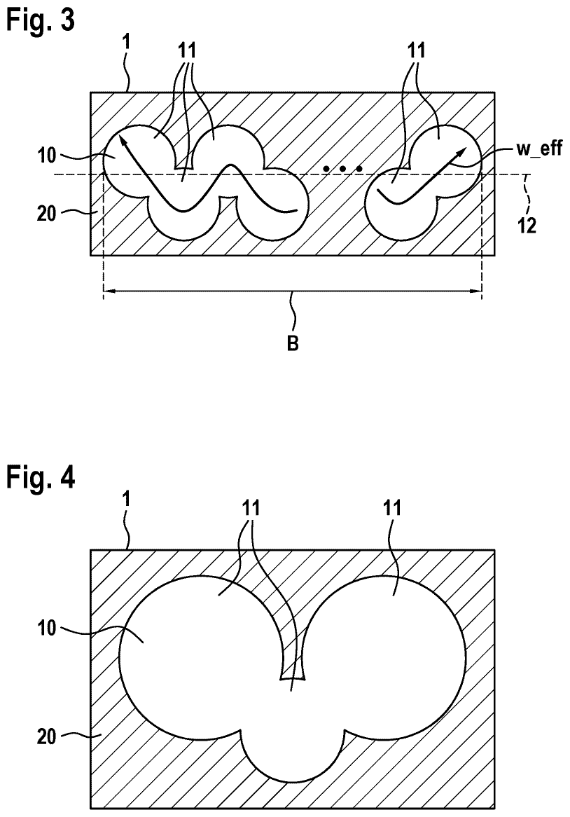

FIG. 3 shows a schematic representation of a cross-section through a waveguide element 1 according to another embodiment. As shown in FIG. 3, the cavity 10 of the waveguide element 1 can also be formed by more than just three or four overlapping geometric elements 11 arranged in a row.

FIG. 4 shows a schematic representation of a cross-section through a waveguide element 1 according to yet another embodiment. The cavity 10 of the waveguide element 1 according to FIG. 4 differs from the above-described embodiments in particular in that the individual geometric elements 11 partially are different sizes.

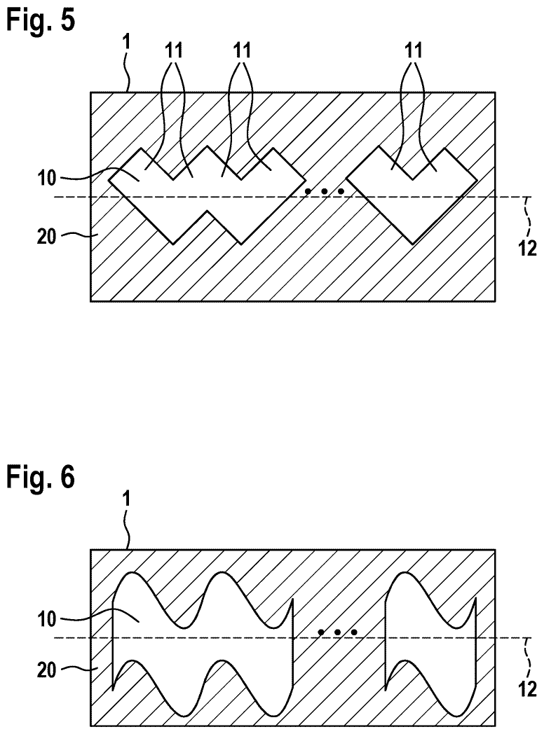

FIG. 5 shows a schematic representation of a cross-section through a waveguide element 1 according to another embodiment. The cavity 10 of the waveguide element 1 according to FIG. 5 differs from the above-described embodiments in that rectangular elements 11 instead of circular elements 11 are provided here for forming the cavity 10. The individual rectangular elements 11 are arranged to form a zigzag-shaped structure, which alternates along the virtual line 12.

FIG. 6 shows a schematic representation of a cross-section through a waveguide element 1 according to another embodiment. The cavity 10 of the waveguide element 11 is realized as a wave-shaped structure, similar to a sinusoidal function. This structure also has a regular alternating shape with respect to the virtual line 12.

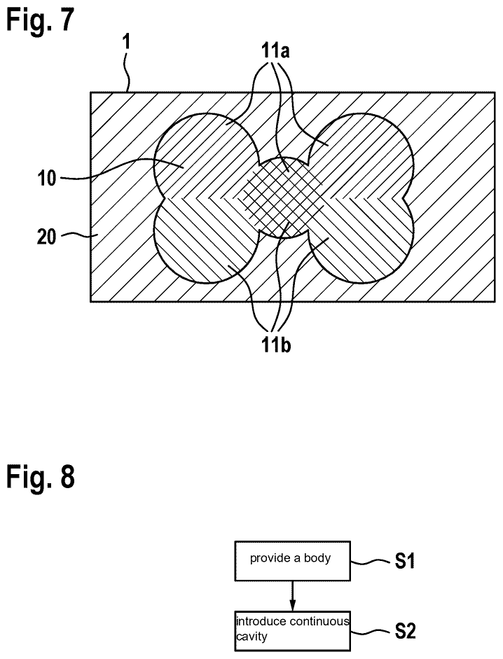

Finally, FIG. 7 shows a schematic representation of a cross-section through a waveguide element 1 according to yet another embodiment. The cavity 10 in this embodiment can, for example, be formed by a combination of two symmetrical structures according to FIG. 2. For better illustration, the individual structures are hatched differently. The geometric elements 11a of the first structure are axially symmetric with respect to the geometric elements 11b of the second structure. This also allows an effective length w_eff to be achieved that is increased with respect to the width B.

FIG. 8 shows a flowchart of a method for producing a waveguide element 1 according to one embodiment. The method can generally comprise any steps that may be necessary to realize one of the above-described waveguide elements 1.

In step S1, a body is first provided. It can be, for example, a solid metallic body or a body made of an electrically conductive material having the outer dimensions of the desired waveguide element 1.

In step S2, a continuous cavity 10 is introduced into the body. The cavity can be introduced for example by drilling, milling or another mechanical machining method. If the body is a body made of a material that is not electrically conductive, the edge region of the cavity can be provided with an electrically conductive material in a further step.

In addition, the waveguide can also be realized by means of an extrusion process or the like, wherein a waveguide structure having the desired cavity is formed from the material (for example in the form of a body).

The resulting cavity 10 in the body has a cross-section perpendicular to an intended propagation direction of an electromagnetic wave, which cross-section has an alternating regular structure along a virtual axis 12. In particular, the cavity 10 can have one of the structures already described in connection with FIGS. 1 to 7. If necessary, the cavity can also be filled with a desired dielectric.

In summary, the present invention relates to a waveguide element, in particular a hollow waveguide for transmission of electromagnetic waves. The waveguide element has a cavity surrounded by an electrically conductive material. The cavity is designed so as to afford for electromagnetic waves an effective width which is larger than the actual dimension of the cavity.

1-10. (canceled)

11. A waveguide element for guiding an electromagnetic wave, the element comprising:
a cavity surrounded by an electrically conductive material;
wherein the cavity has a cross-section perpendicular to a propagation direction of the electromagnetic wave, the cross-section having an alternating regular structure along a virtual line in a plane of the cross-section.

12. The waveguide element according to claim 11, wherein the cross-section of the cavity has a periodic regular structure.

13. The waveguide element according to claim 11, wherein the cross-section includes a plurality of overlapping circles or polygons.

14. The waveguide element according to claim 13, wherein the overlapping circles or polygons are the same size as one another.

15. The waveguide element according to claim 11, wherein the cross-section of the cavity has a structure including a plurality of overlapping alternating structures.

16. The waveguide element according to claim 11, wherein the cavity is filled with a gaseous or solid dielectric.

17. The waveguide element according to claim 11, further comprising:
a metallic body into which the cavity has been introduced by drilling, or milling or another mechanical machining method.

18. A radiofrequency arrangement, comprising:
a waveguide element for guiding an electromagnetic wave, the element including:
a cavity surrounded by an electrically conductive material,
wherein the cavity has a cross-section perpendicular to a propagation direction of the electromagnetic wave, the cross-section having an alternating regular structure along a virtual line in a plane of the cross-section; and
a radiofrequency circuit coupled to the waveguide element.

19. A radar system, comprising:
a transmitting and/or receiving unit; and
a waveguide element for guiding an electromagnetic wave, the element including:
a cavity surrounded by an electrically conductive material,
wherein the cavity has a cross-section perpendicular to a propagation direction of the electromagnetic wave, the cross-section having an alternating regular structure along a virtual line in a plane of the cross-section.

20. A method for producing a waveguide element, comprising the following steps:
providing a metallic body;
introducing a continuous cavity into the body by drilling or milling or another mechanical machining method;
wherein the cavity has a cross-section perpendicular to a propagation direction of the electromagnetic wave, the cross-section having an alternating regular structure along a virtual line in a plane of the cross-section;
and wherein the cavity has an electrically conductive edge.
